(19) United States
(12) Patent Application Publication
(10) Pub. No.: US 2019/0380559 A1
(43) Pub. Date: Dec. 19, 2019

(54) DISHWASHING METHOD USING ARTIFICIAL INTELLIGENCE DEVICE AND APPARATUS THEREFOR

(71) Applicant: LG ELECTRONICS INC., Seoul (KR)

(72) Inventors: Seungjun Lee, Seoul (KR); Jichan Maeng, Seoul (KR); Jongjin Park, Seoul (KR)

(73) Assignee: LG ELECTRONICS INC., Seoul (KR)

(21) Appl. No.: 16/554,154

(22) Filed: Aug. 28, 2019

(30) Foreign Application Priority Data
Aug. 6, 2019 (KR) 10-2019-0095533

(51) Int. Cl. A47L 15/00; G06T 7/00; G06T 7/73; G06K 9/62; H04W 72/04; H04W 48/08; G06N 20/00; B05B 12/12

(52) U.S. Cl. CPC A47L 15/0031; G06T 7/0002; G06T 7/74; G06K 9/6256; G06T 2207/10012; H04W 48/08; G06N 20/00; B05B 12/12; G06T 2207/20081; H04W 72/042

(57) ABSTRACT

A dishwashing method using an artificial intelligence device is disclosed. The dishwashing method using an artificial intelligence device includes: creating a first image, which is an image of the inside of a dishwasher including at least one item to be washed by capturing the inside of the dishwasher; creating a second image, which is a three-dimensional version of the first image, based on the first image; obtaining information on the level of soiling on the at least one item based on the first image; mapping the soling level information to the second image; obtaining a path for washwater to reach the at least one item, based on the second image to which the soling level information is mapped; obtaining the positions of at least one water spray nozzle and at least one washwater reflector so as to spray the washwater along the path; and washing the at least one item based on the above path and the above positions. In the present invention, a smart computing device may be associated with an artificial intelligent module, a drone (unmanned aerial vehicle (UAV)) robot, an augmented reality (AR) device, a virtual reality (VR) device, a 5G service-related device, etc.

This application claims the benefit of Korea Patent Application No. 10-2019-0095533 filed on Aug. 6, 2019, which is incorporated herein by reference for all purposes as if fully set forth herein.

### BACKGROUND OF THE INVENTION

### Field of the Invention

The present invention relates to a dishwashing method using an artificial intelligence device, and more particularly, to a dishwashing method and apparatus based on a three-dimensional image reflecting information on soiling on items to be washed.

### Related Art

A dishwasher is a machine for washing dishes. The dishwasher cleans dishes by spraying washwater to items placed in the dishwasher.

In the conventional art, when washing items by a dishwasher, the items need to be placed in the dishwasher in a way that they can fit into a specific inside structure of the dishwasher. This causes inconvenience to the user because they need to put in a lot of time and effort.

Thus, there is a need to save the user the inconvenience of having to spend a lot of time and effort when washing dishes using a dishwasher, by placing items in the dishwasher regardless of a specific inside structure of the dishwasher.

To meet this need, the present invention provides a dishwashing method using an artificial intelligence (AI) device, by which dishes can be washed regardless of the inside structure of a dishwasher.

### SUMMARY OF THE INVENTION

An aspect of the present invention is to solve the above-described needs and/or problems.

Another aspect of the present invention is to provide a method for washing dishes based on a three-dimensional image.

Another aspect of the present invention is to provide a method for washing dishes regardless of the inside structure of a dishwasher, based on a three-dimensional image.

Another aspect of the present invention is to provide a method for washing dishes based on a three-dimensional image reflecting information on soiling on each of items to be washed in a dishwasher, regardless of the inside structure of the dishwasher.

Technical problems to be solved by the present invention are not limited to the above-mentioned technical problems, and other technical problems not mentioned herein may be clearly understood by those skilled in the art from description below.

A dishwashing method using an artificial intelligence device according to an exemplary embodiment of the present invention provides includes: creating a first image, which is an image of the inside of a dishwasher including at least one item to be washed by capturing the inside of the dishwasher; creating a second image, which is a three-dimensional version of the first image, based on the first image; obtaining information on the level of soiling on the at least one item based on the first image; mapping the soling level information to the second image; obtaining a path for washwater to reach the at least one item, based on the second image to which the soling level information is mapped; obtaining the positions of at least one water spray nozzle and at least one washwater so as to spray the washwater along the path; and washing the at least one item based on the above path and the above positions.

The creating of a second image may further include sensing at least one item to be washed individually based on the first image.

The dishwashing method may further include giving feedback to an item sensing learning part included in the dishwasher about item sensing information which is about the at least one item sensed individually, wherein the item sensing information may include at least one among the shape, color, and pattern of the at least one item sensed individually.

The second image may show the size of the at least one item and the placement of the at least one item.

The obtaining of soiling level information may include: sensing the at least one item individually based on the first image; and estimating the level of soiling on the at least one item sensed individually.

The soiling level information may further include at least one between the position of a soiled portion of the at least one item and the degree of soiling on the at least one item.

The soiling level information may correspond to each of the at least one item.

The mapping of the soling level information to the second image may further include saving the soiling level information corresponding to each of the at least one item for each of the at least one item included in the second image.

The washing of the at least one item may further include: moving at least either the at least one water spray nozzle or the at least one washwater reflector based on the obtained path or the obtained positions; rotating the at least one washwater reflector based on the obtained path or the obtained positions; and controlling the at least one washwater spray nozzle to spray washwater.

The at least one water spray nozzle or the at least one washwater reflector may move individually to the obtained positions along a moving rail.

The at least one washwater reflector may rotate at a certain angle to the right or left.

The dishwashing method may further include receiving, from a network, downlink control information (DCI) used for scheduling the transmission of the first image, wherein the first image may be transmitted to the dishwasher based on the DCI.

The dishwashing method may further include performing an initial access procedure with the network based on a synchronization signal block (SSB).

The dishwashing method may further include: controlling a communication part to transmit the first image to an AI processor included in the network; and controlling the communication part to receive AI-processed information from the AI processor.

A smart computing device supporting a dishwashing method using an AI device according to another exemplary embodiment of the present invention may include: a sensing part including at least one sensor; a processor; and a memory having instructions executable by the processor, wherein, according to the instructions, the processor may create a first image, which is an image of the inside of a dishwasher including at least one item to be washed by capturing the inside of the dishwasher, the processor may create a second image, which is a three-dimensional version of the first image, based on the first image, the processor may obtain information on the level of soiling on the at least one item based on the first image, the processor may map the soling level information to the second image, the processor may obtain a path for washwater to reach the at least one item, based on the second image to which the soling level information is mapped, the processor may obtain the positions of at least one water spray nozzle and at least one washwater reflector so as to spray the washwater along the path, and the processor may wash the at least one item based on the above path and the above positions.

The processor may sense at least one item to be washed individually based on the first image.

The processor may give feedback to an item sensing learning part included in the dishwasher about item sensing information which is about the at least one item sensed individually, wherein the item sensing information may include at least one among the shape, color, and pattern of the at least one item sensed individually.

The second image may show the size of the at least one item and the placement of the at least one item.

The processor may sense the at least one item individually based on the first image and estimate the level of soiling on the at least one item sensed individually.

The soiling level information may further include at least one between the position of a soiled portion of the at least one item and the degree of soiling on the at least one item.

The present disclosure has the advantage of washing dishes based on a three-dimensional image.

Another advantage of the present disclosure is to wash dishes regardless of the inside structure of a dishwasher, based on a three-dimensional image.

Another advantage of the present disclosure is to wash dishes based on a three-dimensional image reflecting information on soiling on each of items to be washed in a dishwasher, regardless of the inside structure of the dishwasher.

It is to be understood that the advantages that can be obtained by the present invention are not limited to the aforementioned advantages and other advantages which are not mentioned will be apparent from the following description to the person with an ordinary skill in the art to which the present invention pertains.

### BRIEF DESCRIPTION OF THE DRAWINGS

FIG. 1 illustrates one embodiment of an AI device.

FIG. 2 illustrates a block diagram of a wireless communication system to which the methods proposed herein may be applied.

FIG. 3 illustrates an example of a signal transmission/reception method in a wireless communication system.

FIG. 4 is a block diagram of an AI device according to an exemplary embodiment of the present invention.

FIG. 5 is a view showing an example of a dishwasher to help understanding of the present invention.

FIG. 6 is a view showing an example of a dishwasher to help understanding of the present invention.

FIG. 7 shows an exemplary block diagram of a dishwasher that performs a dishwashing method using an AI device according to an exemplary embodiment of the present invention.

FIG. 8 is a flowchart showing an example of a dishwashing method using an AI device according to an exemplary embodiment of the present invention.

FIG. 9 is a view showing an example of performing a dishwashing method using an AI device according to an exemplary embodiment of the present invention.

FIG. 10 is a flowchart showing an example of a dishwashing method using an AI device according to an exemplary embodiment of the present invention.

FIG. 11 is a view showing an example of performing a dishwashing method using an AI device according to an exemplary embodiment of the present invention.

FIG. 12 is a flowchart showing an example of performing a dishwashing method using an AI device according to an exemplary embodiment of the present invention.

FIG. 13 is a view showing an example of performing a dishwashing method using an AI device according to an exemplary embodiment of the present invention.

FIG. 14 is a flowchart showing an example of performing a dishwashing method using an AI device according to an exemplary embodiment of the present invention.

FIG. 15 is a view showing an example of performing a dishwashing method using an AI device according to an exemplary embodiment of the present invention.

FIG. 16 is a view showing an example of performing a dishwashing method using an AI device according to an exemplary embodiment of the present invention.

FIG. 17 is a flowchart showing an example of a dishwashing method using an AI device according to an exemplary embodiment of the present invention.

For understanding of the present invention, the accompanying drawings included as part of the detailed description provide embodiments of the present invention and describe the technical characteristics of the present invention together with the detailed description.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present invention would unnecessarily obscure the gist of the present invention, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

Hereinafter, 5G communication (5th generation mobile communication) required by an apparatus requiring AI processed information and/or an AI processor will be described through paragraphs A through G.

A. Example of Block Diagram of UE and 5G Network

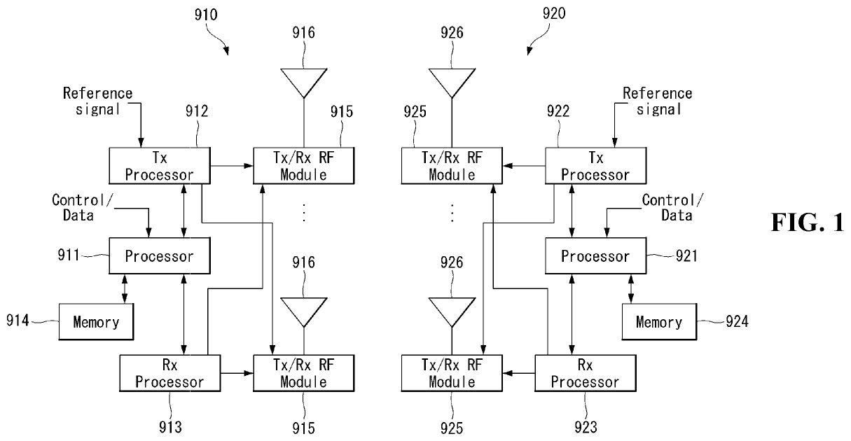

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, the first communication device or the second communication device may be a base station, a network node, a transmission terminal, a reception terminal, a wireless device, a wireless communication device, a vehicle, a vehicle having an autonomous function, a connected car, a drone (Unmanned Aerial Vehicle, UAV), and AI (Artificial Intelligence) module, a robot, an AR (Augmented Reality) device, a VR (Virtual Reality) device, an MR (Mixed Reality) device, a hologram device, a public safety device, an MTC device, an IoT device, a medical device, a Fin Tech device (or financial device), a security device, a climate/environment device, a device associated with 5G services, or other devices associated with the fourth industrial revolution field.

For example, a terminal or user equipment (UE) may include a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. For example, the drone may be a flying object that flies by wireless control signals without a person therein. For example, the VR device may include a device that implements objects or backgrounds of a virtual world. For example, the AR device may include a device that connects and implements objects or background of a virtual world to objects, backgrounds, or the like of a real world. For example, the MR device may include a device that unites and implements objects or background of a virtual world to objects, backgrounds, or the like of a real world. For example, the hologram device may include a device that implements 360-degree 3D images by recording and playing 3D information using the interference phenomenon of light that is generated by two lasers meeting each other which is called holography. For example, the public safety device may include an image repeater or an imaging device that can be worn on the body of a user. For example, the MTC device and the IoT device may be devices that do not require direct interference or operation by a person. For example, the MTC device and the IoT device may include a smart meter, a bending machine, a thermometer, a smart bulb, a door lock, various sensors, or the like. For example, the medical device may be a device that is used to diagnose, treat, attenuate, remove, or prevent diseases. For example, the medical device may be a device that is used to diagnose, treat, attenuate, or correct injuries or disorders. For example, the medial device may be a device that is used to examine, replace, or change structures or functions. For example, the medical device may be a device that is used to control pregnancy. For example, the medical device may include a device for medical treatment, a device for operations, a device for (external) diagnose, a hearing aid, an operation device, or the like. For example, the security device may be a device that is installed to prevent a danger that is likely to occur and to keep safety. For example, the security device may be a camera, a CCTV, a recorder, a black box, or the like. For example, the Fin Tech device may be a device that can provide financial services such as mobile payment.

Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

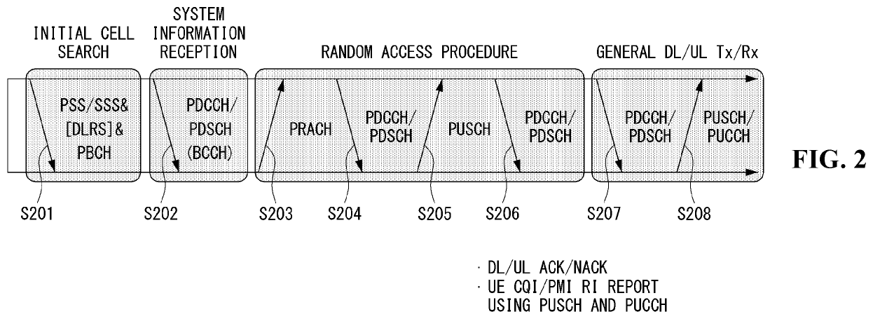

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

An UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation of AI Using 5G Communication

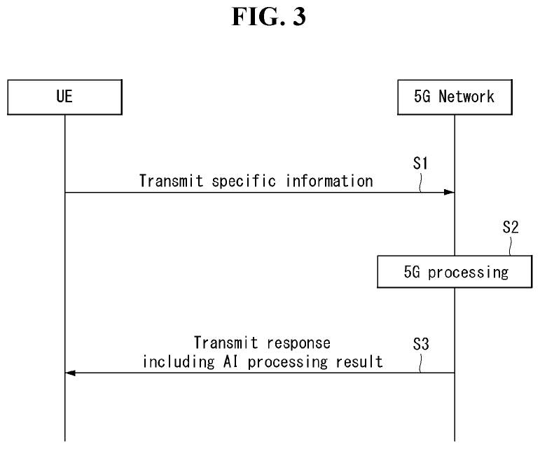

FIG. 3 shows an example of basic operations of an UE and a 5G network in a 5G communication system.

The UE transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the UE (S3).

G. Applied Operations Between UE and 5G Network in 5G Communication System

Hereinafter, the operation of an UE using 5G communication will be described in more detail with reference to wireless communication technology (BM procedure, URLLC, mMTC, etc.) described in FIGS. 1 and 2.

First, a basic procedure of an applied operation to which a method proposed by the present invention which will be described later and eMBB of 5G communication are applied will be described.

As in steps S1 and S3 of FIG. 3, the UE performs an initial access procedure and a random access procedure with the 5G network prior to step S1 of FIG. 3 in order to transmit/receive signals, information and the like to/from the 5G network.

More specifically, the UE performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the UE receives a signal from the 5G network.

In addition, the UE performs a random access procedure with the 5G network for UL synchronization acquisition and/or UL transmission. The 5G network can transmit, to the UE, a UL grant for scheduling transmission of specific information. Accordingly, the UE transmits the specific information to the 5G network on the basis of the UL grant. In addition, the 5G network transmits, to the UE, a DL grant for scheduling transmission of 5G processing results with respect to the specific information. Accordingly, the 5G network can transmit, to the UE, information (or a signal) related to remote control on the basis of the DL grant.

Next, a basic procedure of an applied operation to which a method proposed by the present invention which will be described later and URLLC of 5G communication are applied will be described.

As described above, an UE can receive DownlinkPreemption IE from the 5G network after the UE performs an initial access procedure and/or a random access procedure with the 5G network. Then, the UE receives DCI format 2_1 including a preemption indication from the 5G network on the basis of DownlinkPreemption IE. The UE does not perform (or expect or assume) reception of eMBB data in resources (PRBs and/or OFDM symbols) indicated by the preemption indication. Thereafter, when the UE needs to transmit specific information, the UE can receive a UL grant from the 5G network.

Next, a basic procedure of an applied operation to which a method proposed by the present invention which will be described later and mMTC of 5G communication are applied will be described.

Description will focus on parts in the steps of FIG. 3 which are changed according to application of mMTC.

In step S1 of FIG. 3, the UE receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the UE transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

The above-described 5G communication technology can be combined with methods proposed in the present invention which will be described later and applied or can complement the methods proposed in the present invention to make technical features of the methods concrete and clear.

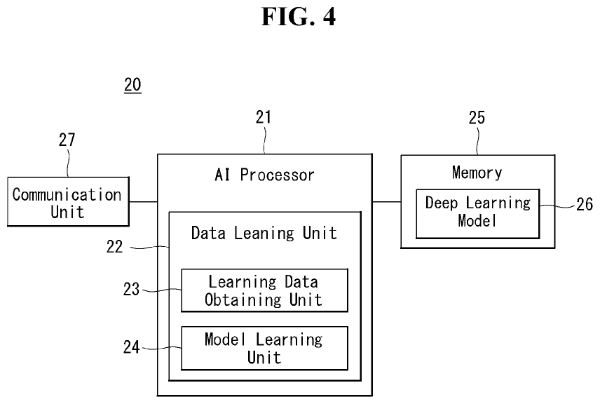

FIG. 4 is a block diagram of an AI device according to an exemplary embodiment of the present invention.

The AI device 20 may include an electronic device including an AI module for performing AI processing or a server including the AI module. Also, the AI device 20 may be included as a component of a particular device and perform at least part of AI processing together with the particular device.

The AI processing may include all operations related to a method provided by the present invention.

The AI device 20 may include an AI processor 21, a memory 25, and/or a communication part 27.

The AI device 20 is a computing device capable of training a neural network, and may be implemented as various electronic devices such as a server, desktop PC, laptop PC, and tablet PC.

The AI processor 21 may train a neural network by using a program stored in the memory 25. Particularly, the AI processor 21 may train a neural network for recognizing data required to perform a method provided by the present invention. Here, the neural network for recognizing data required to perform a method provided by the present invention may be designed to emulate a human brain's structure on a computer, and may include a plurality of network nodes having weights that emulate neurons in a human neural network. The plurality of network nodes may send and receive data through connections so that they emulate the synaptic activity of neurons sending and receiving signals through synapses. Such a neural network may include a deep learning model, which evolved from a neural network model. In the deep learning model, the plurality of network nodes are arranged in different layers, and may send and receive data through convolutions. Examples of the neural network model include various deep learning techniques such as deep neural networks (DNN), convolutional deep neural networks (CNN), recurrent neural networks (RNN), restricted Boltzmann machines (RBM), deep belief networks (DBN), and deep Q-networks, and are applicable to fields including computer vision, speech recognition, natural language processing, and speech/signal processing.

Meanwhile, a processor that performs the above-described functions may be a general-purpose processor (e.g., CPU) or an AI-dedicated processor (e.g., GPU) for artificial intelligence learning.

The memory 25 may store various programs and data required for the control operation of the AI device 20. The memory 25 may be implemented as non-volatile memory, volatile memory, flash memory, hard disk drive (HDD), or solid state drive (SSD). The memory 25 is accessed by the AI processor 21, and the AI processor 21 may read, write, modify, delete, or update data. Also, the memory 25 may store a neural network model (e.g., deep learning model 26) created by a learning algorithm for data classification/recognition according to an exemplary embodiment of the present invention.

Meanwhile, the AI processor 21 may further include a data learning part 22 for training a neural network for data classification/recognition. The data learning part 22 may learn criteria about which learning data it will use to determine on data classification/recognition and how data is classified and recognized using learning data. The data learning part 22 may train a deep learning model by acquiring learning data to be used in learning and applying the acquired learning data to the deep learning model.

The data learning part 22 may be manufactured in the form of at least one hardware chip and mounted on the AI device 20. For example, the data learning part 22 may be manufactured in the form of a hardware chip dedicated to artificial intelligence (AI), or may be manufactured as part of a general-purpose processor (CPU) or dedicated graphics processor (GPU) and mounted on the AI device 20. Also, the data learning part 22 may be implemented as a software module. If it is implemented as a software module (or a program module including instructions), the software module may be stored in a non-transitory computer readable medium. In this case, at least one software module may be provided by an OS (operating system) or by an application.

The data learning part 22 may include a learning data acquisition part 23 and a model training part 24.

The learning data acquisition part 23 may acquire learning data required for a neural network model for classifying and recognizing data. For example, the learning data acquisition part 23 may acquire vehicle data and/or sample data as learning data to feed into the neural network model.

By using the acquired learning data, the model training part 24 may train the neural network model to have criteria for determining how to classify certain data. In this instance, the model training part 24 may train the neural network model through supervised learning which uses at least part of the learning data as the criteria for determination. Alternatively, the model training part 24 may train the neural network model through unsupervised learning which helps find criteria for determination by allowing the neural network model to learn on its own without supervision using the learning data. Also, the model training part 24 may train the neural network model through reinforcement learning by using feedback about whether a right decision is made on a situation by learning. Also, the model training part 24 may train the neural network model by using a learning algorithm including error back-propagation or gradient descent.

Once the neural network model is trained, the model training part 24 may store the trained neural network model in memory. The model training part 24 may store the trained neural network model in a memory of a server connected to the AI device 20 over a wired or wireless network.

The data learning part 22 may further include a learning data preprocessing part (not shown) and a learning data selection part (not shown), in order to improve analysis results from a recognition model or save the resources or time needed to create the recognition model.

The learning data preprocessing part may preprocess acquired data so that the acquired data is used in learning to decide on a situation. For example, the learning data preprocessing part may process acquired learning data into a preset format to enable the model training part 24 to use the acquired data in learning to recognize images.

Moreover, the learning data selection part may select data required for learning from among the learning data acquired by the learning data acquisition part 23 or the learning data preprocessed by the preprocessing part. The selected learning data may be provided to the model learning part 24. For example, the learning data selection part may detect a specific area from an image acquired by a camera of the vehicle so as to select data about an object included in the specific area alone as learning data.

In addition, the data learning part 22 may further include a model evaluation part (not shown) for improving analysis results from the neural network model.

The model evaluation part may feed evaluation data into the neural network model, and, if analysis results produced from the evaluation data do not satisfy a predetermined criterion, may get the model training part 24 to train the neural network model again. In this case, the evaluation data may be data that is defined for evaluating the recognition model. In an example, if the number or proportion of evaluation data from which inaccurate analysis results are produced by analyzing the recognition model trained on the evaluation data exceeds a preset threshold, the model evaluation part may evaluate the analysis results as not satisfying the predetermined criterion.

The communication part 27 may transmit AI processing results from the AI processor 21 to an external electronic device.

Here, the external electronic device may be defined as an autonomous vehicle. Also, the AI device 20 may be defined as another vehicle communicating with the autonomous vehicle or a 5G network. Meanwhile, the AI device 20 may be functionally embedded into a self-driving module equipped in the vehicle. Moreover, the 5G network may include a server or module that performs autonomous driving-related control.

Although the AI device 20 shown in FIG. 4 has been described as being functionally divided into the AI processor 21, the memory 25, the communication part 27, etc., the above-described components may be integrated into one module and called an AI module.

Regarding the Present Invention

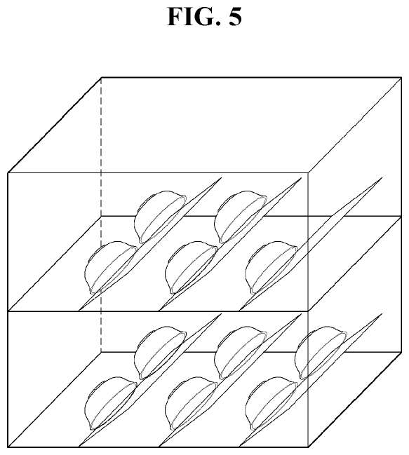

As in FIG. 5, in the conventional art, when washing items by a dishwater, the items need to be placed in the dishwasher in a way that they can fit into a specific inside structure of the dishwasher. This causes inconvenience to the user because they need to put in a lot of time and effort.

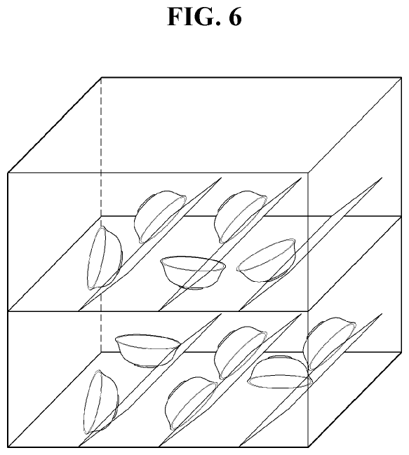

Thus, as in FIG. 6, there is a need to save the user the inconvenience of having to spend a lot of time and effort when washing dishes using a dishwasher, by placing items in the dishwasher regardless of a specific inside structure of the dishwasher.

To meet this need, the present invention provides a dishwashing method using an artificial intelligence (AI) device, by which dishes can be washed regardless of the inside structure of a dishwasher.

More specifically, the present invention provides a dishwashing method using an AI device, which allows for washing of dishes regardless of the inside structure of the dishwasher based on three-dimensional image and degree of soiling by capturing photographs of the inside of a dishwasher where items to be washed are randomly arranged by an inside camera, creating a three-dimensional image of the inside of the dishwasher from the captured photographs of the inside, and determining the degree of soiling on the items.

Hereinafter, a dishwashing method using an AI (artificial intelligence) device provided by the present invention will be described in details.

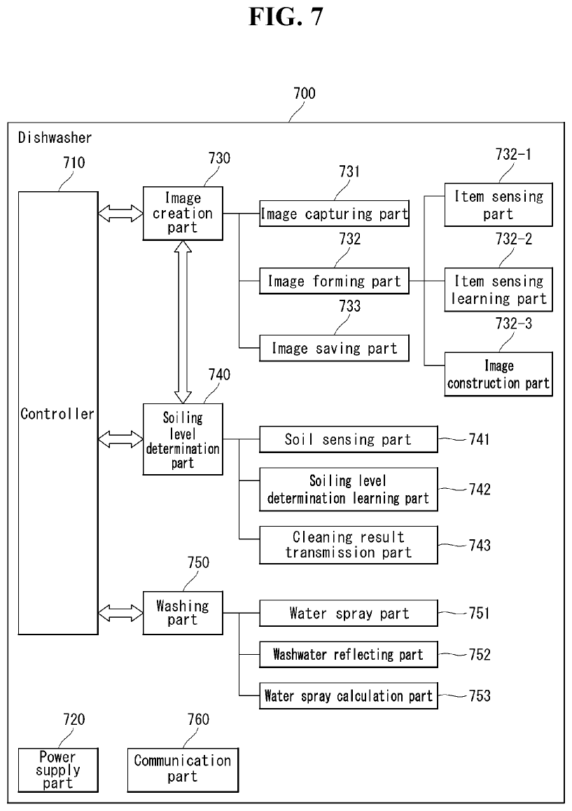

FIG. 7 shows an exemplary block diagram of a dishwasher that performs a dishwashing method using an AI device according to an exemplary embodiment of the present invention.

A dishwasher 700 using an AI device according to an exemplary embodiment of the present invention includes a controller 710, a power supply part 720, an image creation part 730, a soiling level determination part 740, a washing part 750, and a communication part 760.

The controller 710 controls or interacts with the image creation part 730, soiling level determination part 740, and washing part 750. The interaction may mean sending and receiving necessary information among the components of the dishwasher.

The power supply part 720 supplies electric power to the dishwasher.

The image creation part 730 includes an image capturing part 731, an image forming part 732, and an image saving part 733.

The image creation part 730 creates an image required to perform a dishwashing method using an AI device provided by the present invention. To create the required image, the image capturing part 731 captures an image of the inside of the dishwasher 700 and sends the captured inside image to the image forming part 732 and the soiling level determination part 740. The inside image may be a photograph or video.

The image forming part 732 includes an item sensing part 732-1, an item sensing learning part 732-2, and an image construction part 732-3. The image forming part 732 forms a three-dimensional image based on the received inside image. Also, the image forming part 732 sends the formed image to the image saving part 733.

The item sensing part 732-1 senses items included in the inside image received from the image capturing part 731 by working together with the item sensing learning part 732-2, and sends images of the sensed items to the image construction part 732-3. The item sensing learning part 732-2 helps the item sensing part 732-1 sense items. The item sensing learning part 732-2 may learn to sense items. Specifically, information about sensed items may be learned, and the learned information may be saved and used later when sensing other items. The image construction part 732-3 creates a three-dimensional image based on the images sent from the item sensing part 732-1.

The image saving part 733 saves a three-dimensional image sent from the image forming part 732. The saved three-dimensional image may be changed with each step of operating the dishwasher 700.

Moreover, the soiling level determination part 740 includes a soil sensing part 741, a soiling level determination learning part 742, and a cleaning result transmission part 743, which determines the level of soiling on items based on an inside image sent from the image capturing part 731.

The soil sensing part 741 senses soil on items based on the inside image sent from the image capturing part 731. If the soil sensing part 741 senses soiled items, the soiling level determination learning part 742 may determine the level of soiling on the sensed items and map the level of soiling to the three-dimensional image saved in the image saving part 733. That is, the level of soiling may be applied to the items present on the three-dimensional image. Once the level of soiling is applied to the three-dimensional image, the three-dimensional image may be updated with the level of soiling. The level of soiling may involve at least one between the area of a soiled portion or the degree of soiling on that portion.

The cleaning result transmission part 743 generates information related to a cleaning result after cleaning and gives feedback about this to the soiling level determination learning part 742. The soiling level determination learning part 742 may learn to determine soiling level by using the cleaning result-related information.

Moreover, the cleaning result-related information may be sent to the image saving part 741 and applied to the three-dimensional image saved in the image saving part 741. Once the cleaning result is applied, the three-dimensional image may be updated.

In addition, the washing part 750 includes a water spray part 751, a washwater reflecting part 752, and a water spray calculation part 753.

The water spray calculation part 753 calculates the path of washwater to be sprayed onto the items. To calculate the path, the three-dimensional image saved in the image saving part 733 is used. Also, the positions of the water spray part 751 and washwater reflecting part 752 are properly determined so that washwater reaches through the calculated path.

The washing part 750 washes the items by the water spray part 751 and the washwater reflecting part 752, based on the calculated path and positions.

The water spray part 751 sprays washwater through the calculated path, and the washwater reflecting part 752 reflects the sprayed washwater to help washing the items. The water spray part 751 and the washwater reflecting part 752 may work in connection with each other.

The communication part 760 may communicate with an external network. Specifically, the dishwasher may transmit an image of the inside of the dishwasher to the external network through the communication part 760, a processing procedure done in the image creation part 730, soiling level determination part 740, and washing part 750 may be performed in the external network, and information (a three-dimensional image reflecting soiling levels) created from the processing procedure may be received from the network through the communication part 760.

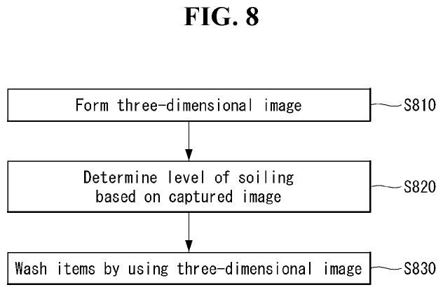

FIG. 8 is a flowchart showing an example of a dishwashing method using an AI device according to an exemplary embodiment of the present invention.

FIG. 8 schematically shows the steps of how a dishwasher performs a dishwashing method using an AI device provided by the present invention.

First of all, the dishwasher forms a three-dimensional image (S810). The three-dimensional image is created based on an image (inside image) captured by a camera inside the dishwasher.

The captured image may be a still image or an image that shows a real-time status of the inside of the dishwasher. For ease of explanation, the following description will be given on the assumption that the captured image is an image showing a real-time status of the inside of the dishwasher, but the present invention is not limited thereto.

Next, the dishwasher determines the level of soiling on the items based on the captured image (S820). The level of soiling may be determined on each of the items arranged inside the dishwasher, and soiling level information including information on the level of soiling may be created for each individual item. That is, if there are five items inside the dishwasher, there may be five pieces of soiling level information.

Lastly, the dishwasher washes the items by using the three-dimensional image (S830). The dishwasher may wash the items based on the three-dimensional image and soiling levels.

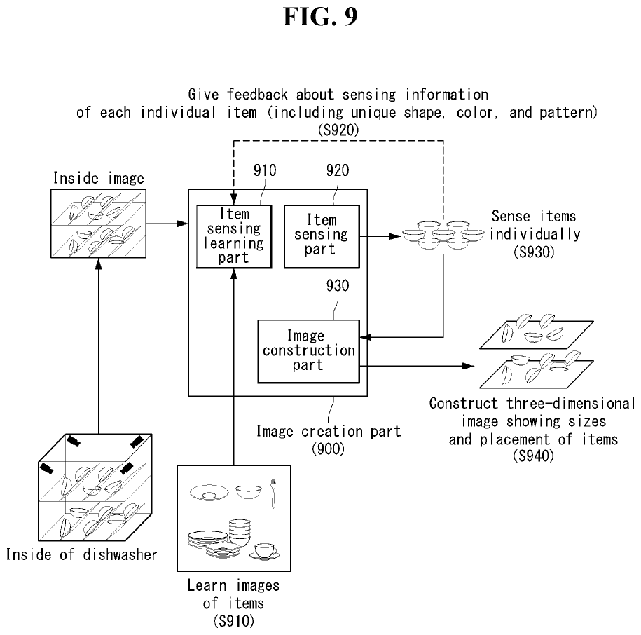

Hereinafter, the above steps S810 to S830 will be described concretely with reference to FIGS. 9 to 15.

FIG. 9 is a view showing an example of performing a dishwashing method using an AI device according to an exemplary embodiment of the present invention.

FIG. 9 schematically shows the steps of the process of FIG. 8 in which the dishwasher forms a three-dimensional image.

An image creation part 900 includes an item sensing learning part 910, an item sensing part 920, and an image construction part 930.

As shown in FIG. 9, the item sensing learning part may learn images of items (S910). For each wash cycle, the item sensing learning part may learn the characteristics of the items and save the learned information.

Although not shown in FIG. 9, the image creation part receives an image of the inside of the dishwasher from the image capturing part.

The item sensing part senses the items included in the inside image (S930). The item sensing learning part may help the item sensing part sense items. The items are individually sensed by the item sensing part. For example, if there are 10 items, the item sensing learning part may sense the 10 items individually.

By sensing the items by the item sensing part, item sensing information may be created. The item sensing part may give feedback to the item sensing learning part about the item sensing information (S920). The item sensing learning part may learn to sense items by using the feedback about the item sensing information. The item sensing information may include information related to the shape, color, and pattern of each of the items.

Moreover, the item sensing part may create an image of each of the individually sensed items. The item sensing part may send the individual images of the sensed items to the image construction part.

The image construction part constructs a three-dimensional image based on the received images (S940). The three-dimensional image may show the sizes and placement of the items.

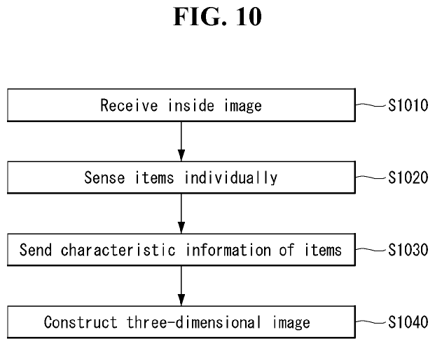

FIG. 10 is a flowchart showing an example of a dishwashing method using an AI device according to an exemplary embodiment of the present invention.

The image creation part in the dishwasher receives a captured inside image from the image capturing part (S1010).

Based on the received inside image, the image creation part in the dishwasher senses the items included in the inside image individually (S1020).

Next, the image creation part in the dishwasher may check out characteristic information of the sensed items and send the characteristic information to the item sensing learning part of the image creation part (S1030). The item sensing learning part of the image creation part may learn the characteristic information.

The dishwasher constructs a three-dimensional image (S1040). The three-dimensional image is used when washing the items.

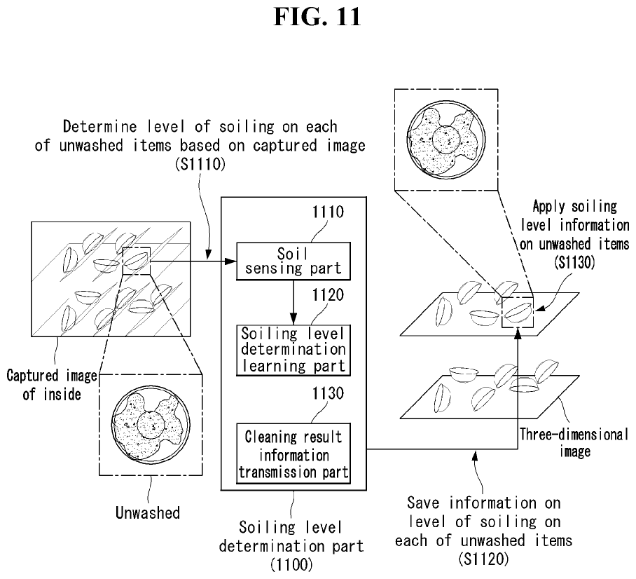

FIG. 11 is a view showing an example of performing a dishwashing method using an AI device according to an exemplary embodiment of the present invention.

FIG. 11 shows in detail the steps of the process of FIG. 8 in which the dishwasher determines the level of soiling on items based on an image of the inside of the dishwasher.

The soiling level determination part 1100 includes a soil sensing part 1110, a soiling level determination learning part 1120, and a cleaning result information transmission part 1130.

Although not shown in FIG. 11, the soil sensing part receives a captured inside image from the image capturing part.

The soil sensing part may sense soil on items included in the captured inside image, and ask the soiling level determination learning part to determine the level of soiling. Alternatively, once the soil sensing part senses soil on items, the soiling level determination learning part may automatically determine the level of soiling on the items.

Since the captured image is an image captured of unwashed items, the soiling level determination learning part may determine the level of soiling on each of the items included in the captured image (S1110). Based on results of the determination, soiling level information may be created, which is information related to the level of soiling on each item. Specifically, if there are 10 items, 10 pieces of soiling level information may be created.

The soiling level determination part saves the soiling level information in a saved three-dimensional image (S1120). That is, the soiling level information is applied to each of the items included in the three-dimensional image.

By applying the soiling level information, the items included in the three-dimensional image may reflect the soiling level information and be saved (S1130).

That is, it can be said that the items included in the three-dimensional image are saved as unsoiled before the soiling level information is applied, whereas the items included in the three-dimensional image are saved as soiled after the soiling level information is applied.

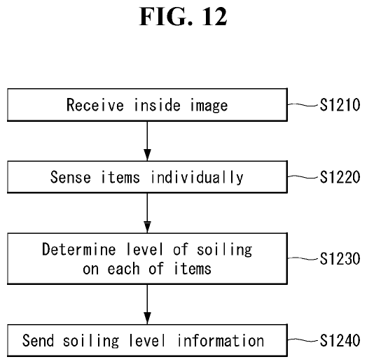

FIG. 12 is a flowchart showing an example of performing a dishwashing method using an AI device according to an exemplary embodiment of the present invention.

The soiling level determination part inside the dishwasher receives a captured inside image from the image capturing part (S1210).

Based on the received inside image, the soiling level determination part inside the dishwasher senses soil on items included in the captured image (S1220).

Next, the soiling level determination part inside the dishwasher determines the level of soiling on the items included in the inside image, and creates soiling level information on each item based on results of the soiling level determination (S1230).

The soiling level determination part inside the dishwasher sends the soiling level information to a three-dimensional image saved in the image saving part (S1240).

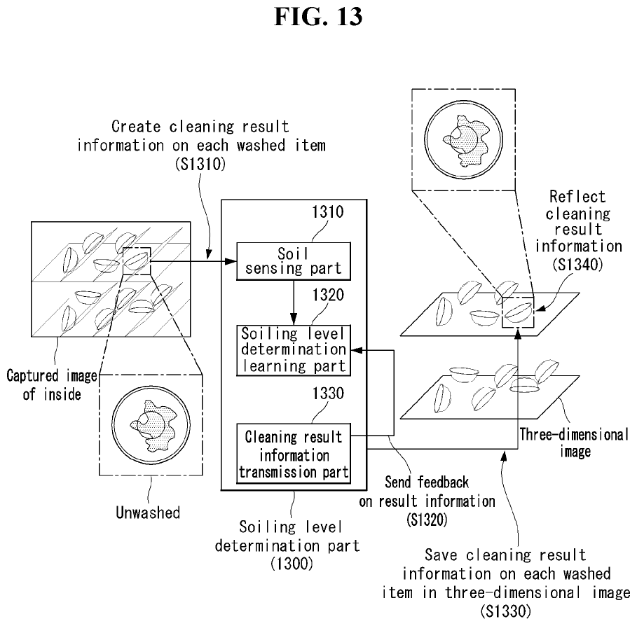

FIG. 13 is a view showing an example of performing a dishwashing method using an AI device according to an exemplary embodiment of the present invention.

FIG. 13 shows in detail the steps of the process of FIG. 8 in which the dishwasher determines the level of soiling on items based on an image of the inside of the dishwasher.

A soiling level determination part 1300 includes a soil sensing part 1310, a soiling level determination learning part 1320, and a cleaning result transmission information part 1330.

Although not shown in FIG. 13, the soil sensing part receives a captured inside image from the image capturing part.

Since the captured image is an image captured of washed items, the soil sensing part and the soiling level determination learning part do not perform any operation for determining the level of soiling on the items.

On the other hand, the cleaning result transmission part checks cleaning results of the items based on the captured image, and creates cleaning result information on each item based on the cleaning results (S1310). Specifically, if there are 10 items, 10 pieces of cleaning result information may be created.

The cleaning result information transmission part sends the cleaning result information to the soiling level determination learning part (S1320). The soiling level determination learning part may learn the cleaning result information.

Moreover, the soiling level determination part saves the cleaning result information in a saved three-dimensional image (S1330). That is, the cleaning result information is applied to each of the items included in the three-dimensional image.

By applying the cleaning result information, the items included in the three-dimensional image may reflect the cleaning result information and be saved (S1340).

That is, it can be said that the items reflecting the soiling level information are saved as soiled in the three-dimensional image before the cleaning result information is applied, whereas the items included in the three-dimensional image are saved as unsoiled after the cleaning result information is applied.

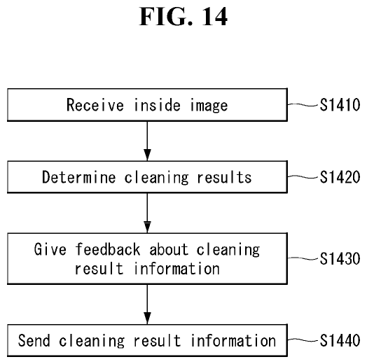

FIG. 14 is a flowchart showing an example of performing a dishwashing method using an AI device according to an exemplary embodiment of the present invention.

The soiling level determination part inside the dishwasher receives a captured inside image from the image capturing part (S1410). The inside image is an image of the inside of the dishwasher after cleaning.

Based on the received inside image, the soiling level determination part inside the dishwasher determines cleaning results, and creates cleaning result information based on the cleaning results (S1420).

The soiling level determination learning part is given feedback about the created cleaning result information (S1430). The cleaning result information feedback may be learned by the soiling level determination learning part.

The soiling level determination part inside the dishwasher sends the cleaning result information to a three-dimensional image saved in the image saving part (S1440).

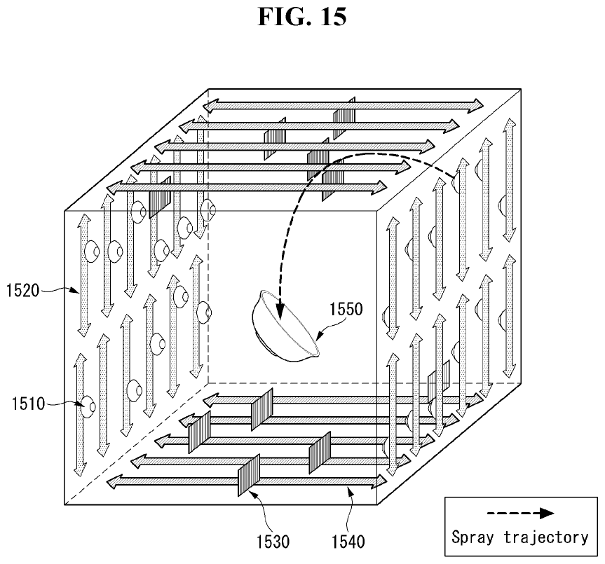

FIG. 15 is a view showing an example of performing a dishwashing method using an AI device according to an exemplary embodiment of the present invention.

FIG. 15 shows in detail the process of FIG. 8 in which the dishwasher washes items using a created three-dimensional image.

Water spray nozzles 1510, moving rails 1520 of the water spray nozzles, washwater reflectors 1530, washwater reflector moving rails 1540, and an item to be washed 1550 are illustrated in this figure. The water spray nozzles may move individually along the water spray nozzle moving rails. Also, the washwater reflectors may move individually along the washwater reflector moving rails.

The water spray nozzles may wash the item by spraying washwater to it. Also, the water spray nozzles may spray washwater to the reflectors so that the washwater is ultimately sprayed along the path where the washwater is reflected off the reflectors.

The dishwasher may calculate the path for washwater to be sprayed onto the item based on a three-dimensional image, and determine the positions of the water spray nozzles and washwater reflectors which allow the washwater to reach the item through the calculated path.

Moreover, the reflectors may rotate to reflect the washwater sprayed by the water spray nozzles in various directions.

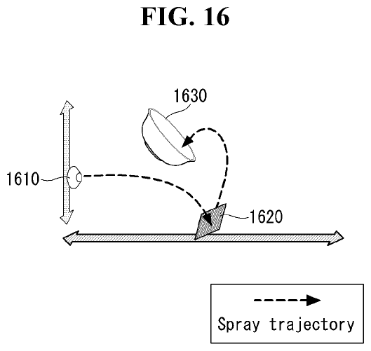

FIG. 16 is a view showing an example of performing a dishwashing method using an AI device according to an exemplary embodiment of the present invention.

FIG. 16 shows in details how the water spray nozzles and the washwater reflectors work together.

If the item is positioned as illustrated in FIG. 16, the washwater sprayed by the water spray nozzles cannot reach the inside surface of the item. In this case, the water spray nozzles may spray washwater to the washwater reflectors, and the washwater reflectors may reflect the washwater sprayed onto them to wash the inside of the item.

The washwater reflectors may be set to have an appropriate angle so that the washwater is reflected and reaches the inside of the item. The dishwasher may set a predetermined rule based on the relationship between the water spray nozzles and the washwater reflectors, to make the waster spray nozzles and the washwater reflectors work together properly. For example, once the positions of the water spray nozzles are set based on the position of the item, the positions and angles of rotation of the washwater reflectors may be set according to a predetermined rule between the water spray nozzles and the washwater reflectors, without any calculation.

By making the waster spray nozzles and the washwater reflectors work together for washing, the item to be washed may be cleaned efficiently by using only a few water spray nozzles.

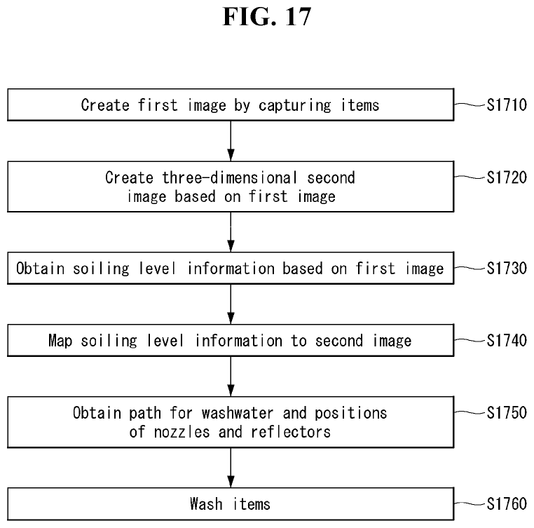

FIG. 17 is a flowchart showing an example of a dishwashing method using an AI device according to an exemplary embodiment of the present invention.

The dishwasher creates a first image, which is an image of the inside of a dishwasher including at least one item to be washed by capturing the inside of the dishwasher (S1710).

Next, the dishwasher creates a second image, which is a three-dimensional version of the first image, based on the first image (S1720).

Next, the dishwasher obtains information on the level of soiling on the at least one item based on the first image (S1730).

Next, the dishwasher maps the soling level information to the second image (S1740).

Afterwards, the dishwasher may obtain a path for washwater to reach the at least one item, based on the second image to which the soling level information is mapped, and may obtain the positions of at least one water spray nozzle and at least one washwater reflector so as to spray the washwater along the path (S1750).

The at least one item is washed based on the above path and the above positions (S1760).

### Exemplary Embodiment 1

A dishwashing method using an AI device may include: creating a first image, which is an image of the inside of a dishwasher including at least one item to be washed by capturing the inside of the dishwasher; creating a second image, which is a three-dimensional version of the first image, based on the first image; obtaining information on the level of soiling on the at least one item based on the first image; mapping the soling level information to the second image; obtaining a path for washwater to reach the at least one item, based on the second image to which the soling level information is mapped; obtaining the positions of at least one water spray nozzle and at least one washwater reflector so as to spray the washwater along the path; and washing the at least one item based on the above path and the above positions.

### Exemplary Embodiment 2

In Exemplary Embodiment 1, the creating of a second image may further include sensing at least one item to be washed individually based on the first image.

### Exemplary Embodiment 3

In Exemplary Embodiment 2, the dishwashing method may further include giving feedback to an item sensing learning part included in the dishwasher about item sensing information which is about the at least one item sensed individually, wherein the item sensing information may include at least one among the shape, color, and pattern of the at least one item sensed individually.

### Exemplary Embodiment 4

In Exemplary Embodiment 1, the second image may show the size of the at least one item and the placement of the at least one item.

### Exemplary Embodiment 5

In Exemplary Embodiment 1, the obtaining of soiling level information may include: sensing the at least one item individually based on the first image; and estimating the level of soiling on the at least one item sensed individually.

### Exemplary Embodiment 6

In Exemplary Embodiment 5, the soiling level information may further include at least one between the position of a soiled portion of the at least one item and the degree of soiling on the at least one item.

### Exemplary Embodiment 7

In Exemplary Embodiment 1, the soiling level information may correspond to each of the at least one item.

### Exemplary Embodiment 8

In Exemplary Embodiment 7, the mapping of the soling level information to the second image may further include saving the soiling level information corresponding to each of the at least one item for each of the at least one item included in the second image.

### Exemplary Embodiment 9

In Exemplary Embodiment 1, the washing of the at least one item may further include: moving at least either the at least one water spray nozzle or the at least one washwater reflector based on the obtained path or the obtained positions; rotating the at least one washwater reflector based on the obtained path or the obtained positions; and controlling the at least one washwater spray nozzle to spray washwater.

### Exemplary Embodiment 10

In Exemplary Embodiment 9, the at least one water spray nozzle or the at least one washwater reflector may move individually to the obtained positions along a moving rail.

### Exemplary Embodiment 11

In Exemplary Embodiment 10, the at least one washwater reflector may rotate at a certain angle to the right or left.

### Exemplary Embodiment 12

In Exemplary Embodiment 1, the dishwashing method may further include receiving, from a network, downlink control information (DCI) used for scheduling the transmission of the first image, wherein the first image may be transmitted to the dishwasher based on the DCI.

### Exemplary Embodiment 13

In Exemplary Embodiment 12, the dishwashing method may further include performing an initial access procedure with the network based on a synchronization signal block (SSB).

### Exemplary Embodiment 14

In Exemplary Embodiment 12, the dishwashing method may further include: controlling a communication part to transmit the first image to an AI processor included in the network; and controlling the communication part to receive AI-processed information from the AI processor.

### Exemplary Embodiment 15

A smart computing device supporting a dishwashing method using an AI device may include: a sensing part including at least one sensor; a processor; and a memory having instructions executable by the processor, wherein, according to the instructions, the processor may create a first image, which is an image of the inside of a dishwasher including at least one item to be washed by capturing the inside of the dishwasher, the processor may create a second image, which is a three-dimensional version of the first image, based on the first image, the processor may obtain information on the level of soiling on the at least one item based on the first image, the processor may map the soling level information to the second image, the processor may obtain a path for washwater to reach the at least one item, based on the second image to which the soling level information is mapped, the processor may obtain the positions of at least one water spray nozzle and at least one washwater reflector so as to spray the washwater along the path, and the processor may wash the at least one item based on the above path and the above positions.

### Exemplary Embodiment 16

In Exemplary Embodiment 15, the processor may sense at least one item to be washed individually based on the first image.

### Exemplary Embodiment 17

In Exemplary Embodiment 16, the processor may give feedback to an item sensing learning part included in the dishwasher about item sensing information which is about the at least one item sensed individually, wherein the item sensing information may include at least one among the shape, color, and pattern of the at least one item sensed individually.

### Exemplary Embodiment 18

In Exemplary Embodiment 15, the second image may show the size of the at least one item and the placement of the at least one item.

### Exemplary Embodiment 19

In Exemplary Embodiment 15, the processor may sense the at least one item individually based on the first image and estimate the level of soiling on the at least one item sensed individually.

### Exemplary Embodiment 20

In Exemplary Embodiment 19, the soiling level information may further include at least one between the position of a soiled portion of the at least one item and the degree of soiling on the at least one item.

### Exemplary Embodiment 21

In Exemplary Embodiment 15, the soiling level information may correspond to each of the at least one item.

### Exemplary Embodiment 22

In Exemplary Embodiment 21, the processor may save the soiling level information corresponding to each of the at least one item for each of the at least one item included in the second image, in order to map the soling level information to the second image.

### Exemplary Embodiment 23

In Exemplary Embodiment 15, the processor may move at least either the at least one water spray nozzle or the at least one washwater reflector based on the obtained path or the obtained positions, rotate the at least one washwater reflector based on the obtained path or the obtained positions, and control the at least one washwater spray nozzle to spray washwater, in order to wash the at least one item.

### Exemplary Embodiment 24

In Exemplary Embodiment 23, the at least one water spray nozzle or the at least one washwater reflector may move individually to the obtained positions along a moving rail.

### Exemplary Embodiment 25

In Exemplary Embodiment 24, the at least one washwater reflector may rotate at a certain angle to the right or left.

### Exemplary Embodiment 26

In Exemplary Embodiment 15, the smart computing device may further include a communication part, wherein the processor controls the communication part to receive from a network downlink control information, DCI, used for scheduling the transmission of the first image, wherein the first image may be transmitted to the dishwasher based on the DCI.

### Exemplary Embodiment 27

In Exemplary Embodiment 26, the processor may perform an initial access procedure with the network based on a synchronization signal block (SSB).

### Exemplary Embodiment 28

In Exemplary Embodiment 26, the processor may control a communication part to transmit the first image to an AI processor included in the network and control the communication part to receive AI-processed information from the AI processor.

Advantageous effects of a dishwashing method using an AI device according to the present invention will be described below. At least one of the exemplary embodiments of the present invention may provide a method for washing dishes based on a three-dimensional image. At least one of the exemplary embodiments of the present invention may provide a method for washing dishes regardless of the inside structure of a dishwasher, based on a three-dimensional image. At least one of the exemplary embodiments of the present invention may provide a method for washing dishes based on a three-dimensional image reflecting information on soiling on each of items to be washed in a dishwasher, regardless of the inside structure of the dishwasher.

Advantageous effects of a smart computing device according to the present invention will be described below. At least one of the exemplary embodiments of the present invention may provide a smart computing device for washing dishes based on a three-dimensional image. At least one of the exemplary embodiments of the present invention may provide a smart computing device for washing dishes regardless of the inside structure of a dishwasher, based on a three-dimensional image. At least one of the exemplary embodiments of the present invention may provide a smart computing device for washing dishes based on a three-dimensional image reflecting information on soiling on each of items to be washed in a dishwasher, regardless of the inside structure of the dishwasher.

The present invention described above may be implemented in computer-readable codes in a computer readable recording medium, and the computer readable recording medium may include all kinds of recording devices for storing data that is readable by a computer system. Examples of the computer readable recording medium include HDD (Hard Disk Drive), SSD (Solid State Disk), SDD (Silicon Disk Drive), ROM, RAM, CD-ROM, magnetic tape, floppy disk, optical data storage device, and the like, and may be implemented in the form of carrier waves (e.g., transmission through the internet). Accordingly, the foregoing detailed description should not be interpreted as restrictive in all aspects, and should be considered as illustrative. The scope of the present invention should be determined by rational interpretation of the appended claims, and all changes within the equivalent scope of the present invention are included in the scope of the present invention.

The features, structures, and effects described in the present disclosure are included in at least one embodiment but are not necessarily limited to a particular embodiment. A person skilled in the art can apply the features, structures, and effects illustrated in the particular embodiment to another embodiment by combining or modifying such features, structures, and effects. It should be understood that all such combinations and modifications are included within the scope of the present disclosure.

Although the embodiments have been mainly described until now, they are just exemplary and do not limit the present invention. Thus, those skilled in the art to which the present invention pertains will know that various modifications and applications which have not been exemplified may be carried out within a range which does not deviate from the essential characteristics of the embodiments. For example, the constituent elements described in detail in the exemplary embodiments can be modified to be carried out. Further, the differences related to such modifications and applications shall be construed to be included in the scope of the present invention specified in the attached claims.

What is claimed is:

1. A dishwashing method using an artificial intelligence device, the dishwashing method comprising:
creating a first image, which is an image of the inside of a dishwasher including at least one item to be washed by capturing the inside of the dishwasher;
creating a second image, which is a three-dimensional version of the first image, based on the first image;
obtaining information on the level of soiling on the at least one item based on the first image;
mapping the soling level information to the second image;
obtaining a path for washwater to reach the at least one item, based on the second image to which the soling level information is mapped;
obtaining the positions of at least one water spray nozzle and at least one washwater reflector so as to spray the washwater along the path; and
washing the at least one item based on the above path and the above positions.

2. The dishwashing method of claim 1, wherein the creating of a second image further comprises sensing at least one item to be washed individually based on the first image.

3. The dishwashing method of claim 2, further comprising giving feedback to an item sensing learning part included in the dishwasher about item sensing information which is about the at least one item sensed individually,
wherein the item sensing information comprises at least one among the shape, color, and pattern of the at least one item sensed individually.

4. The dishwashing method of claim 1, wherein the second image shows the size of the at least one item and the placement of the at least one item.

5. The dishwashing method of claim 1, wherein the obtaining of soiling level information comprises:
sensing the at least one item individually based on the first image; and
estimating the level of soiling on the at least one item sensed individually.

6. The dishwashing method of claim 5, wherein the soiling level information further comprises at least one between the position of a soiled portion of the at least one item and the degree of soiling on the at least one item.

7. The dishwashing method of claim 1, wherein the soiling level information corresponds to each of the at least one item.

8. The dishwashing method of claim 7, wherein the mapping of the soling level information to the second image further comprises saving the soiling level information corresponding to each of the at least one item for each of the at least one item included in the second image.

9. The dishwashing method of claim 1, wherein the washing of the at least one item further comprises:
moving at least either the at least one water spray nozzle or the at least one washwater reflector based on the obtained path or the obtained positions;
rotating the at least one washwater reflector based on the obtained path or the obtained positions; and
controlling the at least one washwater spray nozzle to spray washwater.

10. The dishwashing method of claim 9, wherein the at least one water spray nozzle or the at least one washwater reflector moves individually to the obtained positions along a moving rail.

11. The dishwashing method of claim 10, wherein the at least one washwater reflector rotates at a certain angle to the right or left.

12. The dishwashing method of claim 1, further comprising receiving, from a network, downlink control information, DCI, used for scheduling the transmission of the first image,
wherein the first image is transmitted to the dishwasher based on the DCI.

13. The dishwashing method of claim 12, further comprising performing an initial access procedure with the network based on a synchronization signal block, SSB.

14. The dishwashing method of claim 12, further comprising:
controlling a communication part to transmit the first image to an AI processor included in the network; and
controlling the communication part to receive AI-processed information from the AI processor.

15. A smart computing device supporting a dishwashing method using an artificial intelligence device, the smart computing device comprising:
a sensing part including at least one sensor;
a processor; and
a memory having instructions executable by the processor,
wherein, according to the instructions, the processor creates a first image, which is an image of the inside of a dishwasher including at least one item to be washed by capturing the inside of the dishwasher, the processor creates a second image, which is a three-dimensional version of the first image, based on the first image, the processor obtains information on the level of soiling on the at least one item based on the first image, the processor maps the soling level information to the second image, the processor obtains a path for washwater to reach the at least one item, based on the second image to which the soling level information is mapped, the processor obtains the positions of at least one water spray nozzle and at least one washwater reflector so as to spray the washwater along the path, and the processor washes the at least one item based on the above path and the above positions.

16. The smart computing device of claim 15, wherein the processor senses at least one item to be washed individually based on the first image.

17. The smart computing device of claim 16, wherein the processor gives feedback to an item sensing learning part included in the dishwasher about item sensing information which is about the at least one item sensed individually,
wherein the item sensing information comprises at least one among the shape, color, and pattern of the at least one item sensed individually.

18. The smart computing device of claim 15, wherein the second image shows the size of the at least one item and the placement of the at least one item.

19. The smart computing device of claim 15, wherein the processor senses the at least one item individually based on the first image and estimates the level of soiling on the at least one item sensed individually.

20. The smart computing device of claim 19, wherein the soiling level information further comprises at least one between the position of a soiled portion of the at least one item and the degree of soiling on the at least one item.
